(19) United States
(12) Patent Application Publication
(10) Pub. No.: US 2013/0024058 A1
(43) Pub. Date: Jan. 24, 2013

(54) HILL START ASSIST CONTROL METHOD FOR USE IN HYBRID ELECTRIC VEHICLES

(71) Applicant: Kyung Su Han, Hwaseong (KR)

(72) Inventor: Kyung Su Han, Hwaseong (KR)

(73) Assignee: HYUNDAI MOTOR COMPANY, Seoul (KR)

(21) Appl. No.: 13/313,877

(22) Filed: Dec. 7, 2011

(30) Foreign Application Priority Data
Jul. 22, 2011 (KR) 10-2011-0072733

(51) Int. Cl. B60W 20/00

(52) U.S. Cl. 701/22; 180/65.275; 903/902

(57) ABSTRACT

Disclosed is a hill start assist control (HAC) system and method for use in a hybrid electric vehicle incorporating an EHS which includes a hybrid control unit that is configured to determine the operational state of the EHS when the hybrid electric vehicle is stopped and is being restarted on a slope, and controls the operation state of the EHS to be released when it is determined by the controller that the EHS should be operated.

### CROSS-REFERENCE TO RELATED APPLICATION

This application claims under 35 U.S.C. §119(a) the benefit of Korean Patent Application No. 10-2011-0072733 filed on Jul. 22, 2011 the entire contents of which are incorporated herein by reference.

### BACKGROUND OF THE INVENTION

1. Field of the Invention

The present invention relates, in general, to a hill start assist control (HAC) method for use in hybrid electric vehicles. More specifically, when hybrid electric vehicles stop and restart on slopes, the present invention prevents the vehicles from being delaying takeoff or rolling backwards on slopes even under a variety of running conditions (idling stop state, EV mode, etc.).

2. Description of the Related Art

Generally, a transmission (T/M) is operated so that when a brake is depressed or on, a clutch between the T/M and an engine is free of a gear set so power is not transmitted from the engine to the gear set, and when the brake is off, the clutch becomes engaged with the gear set so as to transmit power from the engine to the gear set.

Here, when vehicles stop and restart on slopes, vehicles typically roll backwards unless sufficient power is transmitted to drive wheels from the engine. To solve this problem, an easy hill starter (EHS) assist device has been developed which prevents the vehicle from rolling backwards by maintaining control over brake pressure through the use of input signals related to the vehicle speed, positions of brake pedal and gears, or the like, and assists take off of the vehicle by releasing the brake force in response to detection of a driver manipulation signal (e.g. manipulation of an accelerator pedal).

This easy hill starter (EHS) assist device is configured to determine a release point thereof upon receiving the connection signal of a clutch. In the case of hybrid electric vehicles, an idling stop frequently occurs. In addition, in EV mode, the hybrid electric vehicles start only by actuating a drive motor without connecting the clutch when the vehicles stop and restart, thus causing the vehicles roll backwards when the vehicles are come to an idling stop and are re-started. Accordingly, it is difficult to determine the release point of the EHS just by using the connection signal of the clutch. As a result, another approach is required.

Additionally, hybrid electric vehicles include a creeping aided system (CAS) for preventing them from rolling backwards. Also, by turning on the CAS for a certain period after a brake-release point, the hydraulic pressure is controlled to be continuously applied for a certain period of time regardless of the brake signal from the driver, so that the vehicle is prevented from rolling backwards.

However, in the case of hybrid vehicle, the operating time of the CAS varies depending on the gradient obtained from a gradient detecting sensor. And, the time for which the CAS is operated in the idling stop state is controlled to be equal to the operating time of the CAS in a state of the vehicles being stopped, which is different in all respects from the idling stop state. In this case, since the engine is turned off in the idling stop state and takes some time to start, it takes a long time to transmit power from the engine to a drive shaft when the vehicle starts.

Accordingly, unless the operating time of the CAS is not varied depending on the start state of the engine, the CAS is unnecessarily operated for a long time before the engine is turned on, so that the vehicle starts slowly. Also, when the engine is idling during a stop, the time for which the CAS is operated becomes too short due to start time of the engine and therefore the vehicle rolls backwards on the slope.

As such, a method is strongly needed in which a conventional easy hill starter (EHS) assist device can be incorporated into hybrid vehicles and the assist device is controlled so as to adapt to driving conditions.

The above descriptions illustrated in the background part are intended to help understand the background of the present invention, but are not intended to be the prior art well known to

### SUMMARY OF THE INVENTION

Accordingly, the present invention has been made keeping in mind the above problems occurring in the related art, and the present invention provides a hill start assist control (HAC) system and method for use in hybrid electric vehicles, which includes incorporating a conventional EHS system in the hybrid electric vehicles and determining the operation state of the EHS system to prevent a starting delay in the vehicles on a hill or rolling backwards on slopes even while in an idling stop state or in the EV mode.

In order to achieve the above object, according to one aspect of the present invention, a hill start assist control (HAC) system and method for use in hybrid electric vehicles incorporating an EHS. More specifically, the present invention determines the operational state of the EHS by a hybrid control unit when the hybrid electric vehicle stops and is restarted on a slope, and releasing the EHS when it is determined by the hybrid control unit that is necessary to release the EHS.

Even more specifically, determining the operational state of the EHS may include checking the operational condition of the EHS to determine whether the EHS is in a predetermined operating condition, and checking whether the EHS is being operated to set the brake force when the predetermined operating conditions of the EHS are determined as being satisfied.

Furthermore, the present invention may also determine whether the EHS is in a normal state or an abnormal state while determining that the predetermined operating conditions of the EHS are satisfied.

Additionally, the release condition of the EHS may be checked to determine whether the EHS is in a predetermined release condition, and an EHS valve of the EHS may be turned off to release the EHS when the predetermined release condition of the EHS is determined to have been satisfied.

In another exemplary embodiment, when the predetermined release condition of the EHS is determined not to have been satisfied, the method may further include a comparing step for comparing and examining an actual torque transmitted to a wheel shaft of actual vehicle and a calculated torque calculated based on a slope angle of the slopes, and a sending step for sending a release signal to the EHS system when the actual torque is larger than the calculated torque.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a configuration view illustrating a hill start assist device for use in hybrid electric vehicles in accordance with one embodiment of the present invention;

FIG. 2 is a flow chart illustrating a hill start assist control (HAC) method for use in hybrid electric vehicles in accordance with one embodiment of the present invention.

### DETAILED DESCRIPTION OF THE INVENTION

Reference will now be made in greater detail to a hill start assist control (HAC) system and method for use in hybrid electric vehicles according to a preferred embodiment of the present invention with reference to the accompanying drawings.

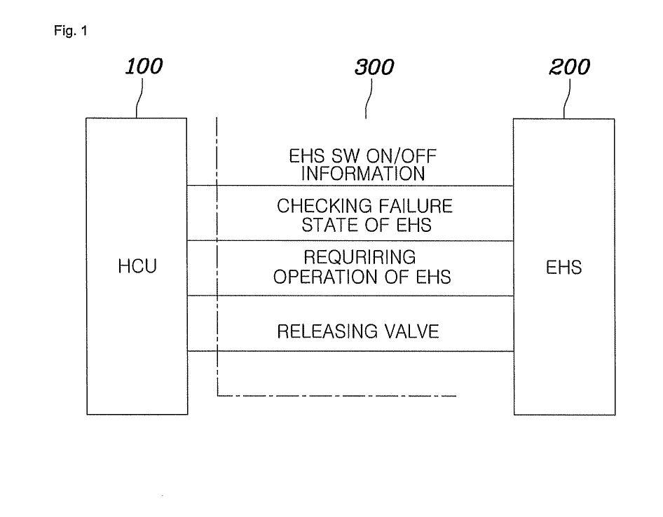

FIG. 1 is a configuration view illustrating a hill start assist device for use in hybrid electric vehicles in accordance with one embodiment of the present invention. The hill start assist device of the present invention includes an easy hill starter 200 (hereinafter, to be referred as “EHS”) configured to detect the vehicle's state on slopes and set or release a brake force, and an interface part 300 configured to transmit information related to an operational state of the easy hill starter to a hybrid control unit 100 and to transmit a release signal from the hybrid control unit to the interface part 300.

The EHS 200 is an auxiliary device for assisting the starting of the vehicles by releasing the brake force in response to detection of a driver manipulation signal (e.g. manipulation of an accelerator pedal) when the vehicle is stopped on a slope. This EHS is configured to monitor input signals such as a vehicle's velocity, a brake pedal, gear position, etc., and to determine whether the input signals need to be controlled, and then operate a valve in a holding state to maintain the brake force. More specifically, the operator may be informed of a procedure regarding maintaining or releasing the brake force of the EHS 200 by an alarm such as lamp or buzzer.

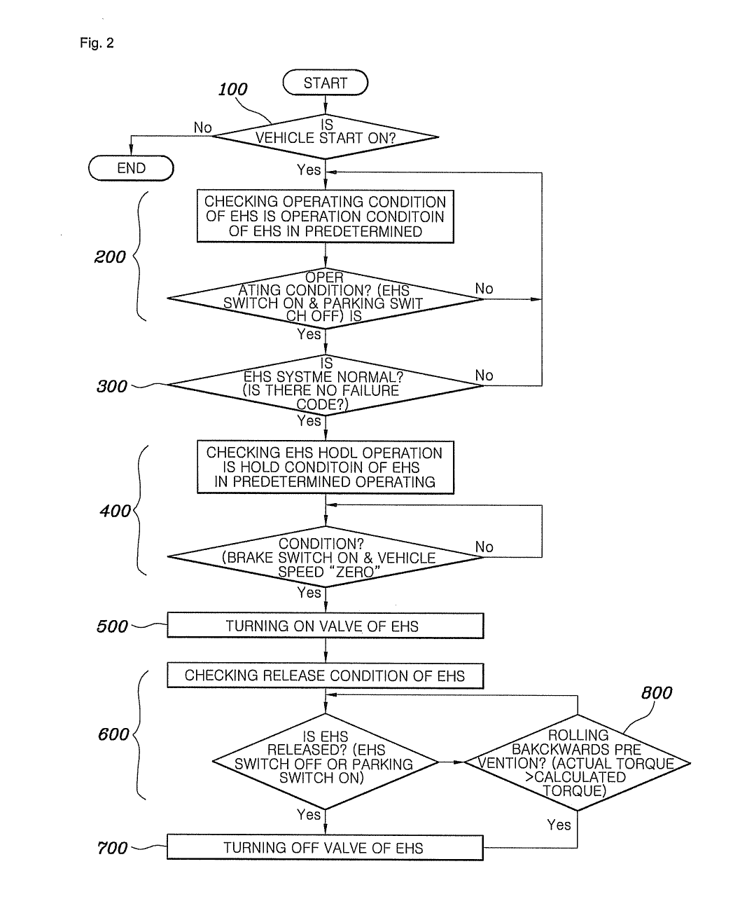

FIG. 2 is a flow chart illustrating a hill start assist control (HAC) method for use hybrid electric vehicles in accordance with one embodiment of the present invention. The hill start assist control method for use in hybrid electric vehicles mounted with the EHS determines the operational state of the EHS 200 by a hybrid control unit 100 when a hybrid electric vehicle is stopped and restarted on a slope, and controls the operation state of the EHS 200 to be released when it is determined that the EHS should be operated.

Herein, while determining the operational state of the EHS 200, the operating condition of the EHS is checked S200 to determine whether the EHS is in a predetermined operating condition, and whether the EHS should be operated to set the brake force when the predetermined operating condition of the EHS is determined to be satisfied S400.

In addition, the method may further include a system determining step S300 for determining whether the ESH is in a normal state or an abnormal state when it is determined that the predetermined operating conditions of the EHS have been satisfied.

Meanwhile, the operation releasing step may include a release condition determining step S600 for checking the release condition of the EHS to determine whether the EHS is in a predetermined release condition, and a release step S700 for turning off the EHS valve of the EHS to release the EHS when the predetermined release conditions of the EHS are determined to have been satisfied. And, when the predetermined release conditions of the EHS are determined not to have been satisfied, the method may further include a comparison step S800 for comparing and examining an actual torque transmitted to a wheel shaft of actual vehicle and a calculated torque calculated based on a slope angle of the slopes, and a sending step for sending a release signal to EHS system and performing the release step S700 when the actual torque is larger than the calculated torque.

Next, an overall control procedure of the hill start assist control method will be described by referring to FIG. 2. When the vehicle is stopped on a slope, first, the hybrid control unit 100 performs a determining step S100 so as to determine whether the engine is turned on and is running. When the engine is determined to have been turned on, an operation condition checking step S200 is performed for checking the operating condition (EHS switch ON & parking switch

Off) of the EHS to determine whether the EHS is in a predetermined operating condition. And then, a determining step S300 for determining whether the ESH is in a normal state or an abnormal state to check the failure state of the EHS when the operating condition checking step determines that the predetermined operating condition of the EHS was satisfied.

When the EHS is in the normal state, the HOLD operation of the EHS is determined. At this time, step S400 is performed for checking whether the operation of the EHS is in a predetermined HOLD condition (e.g., a brake switch is ON and the vehicle's speed is zero). And when the HOLD condition is determined to have been satisfied, the step S500 for turning on the valve of the EHS is performed.

When a vehicle is stopped and restarted on a slope, the operation of the EHS is released. In this case, a step S600 for checking the release condition of the EHS is performed to determine whether the EHS is in a predetermined release condition. When the predetermined release condition of the EHS is determined to have been satisfied, a release step S700 for turning off the valve of the EHS and releasing the operation state thereof is performed and thus the brake force is removed.

In addition, when the predetermined release condition of the EHS is determined not to have been satisfied, a comparing step S800 for comparing and examining an actual torque transmitted to a wheel shaft of an actual vehicle and a calculated torque calculated based on a slope angle of the slope, and a sending step for sending a release signal to the EHS system are performed. Then the release step S700 is performed when the actual torque is larger than the calculated torque.

The actual torque is a torque obtained by multiplying “A” which is obtained by adding the detected torque of the motor and a transfer torque of the clutch and “B” which is obtained by multiplying a gear ratio of the transmission (T/M) and a gear ratio of an axle, and is transmitted to the actual wheel shaft. Also, the calculated torque is a torque calculated based on a gradient detected by a gradient detecting sensor. Accordingly, when the actual torque is larger than the calculated torque, it is possible to prevent the vehicles from rolling backwards even if the operation state of EHS is released.

Furthermore, the present invention may be embodied as computer readable media on a computer readable medium containing executable program instructions executed by a processor, controller or the like, e.g., the hybrid control unit 100. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion.

As apparent from the above description, the hill start assist control (HAC) system and method for use in hybrid electric vehicles according to the present invention provides advantages in that it is possible to prevent the hybrid electric vehicles mounted with an automatic transmission from rolling backwards on a slope and thus improves the merchantability thereof In addition, the idling stop function and the EV mode function are realized to improve the fuel consumption. Also, a conventional EHS system can be used to achieve additional cost effective savings. Furthermore, it is possible to save on costs and to promote technical advances by incorporating the EHS system of automatic transmission vehicles, instead of the CAS system which is incorporated in conventional hybrid electric vehicles.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A hill start assist control (HAC) method for use in a hybrid electric vehicle incorporating an easy hill starter (EHS), comprising:
determining, by a controller, an operational state of the EHS when the hybrid electric vehicle is stopped and restarted on a slope; and
controlling, by the controller, the operational state of the EHS to release the operational state of the EHS when it is determined by the controller that the EHS should be operated.

2. The hill start assist control (HAC) method for use in hybrid electric vehicles as set forth in claim 1, further comprising:
checking one o more operating conditions of the EHS to determine whether the EHS has satisfied one or more predetermined operating condition; and
checking whether the EHS is being operated to apply force to a brake when one or more predetermined operating conditions of the EHS have been satisfied.

3. The hill start assist control (HAC) method for use in hybrid electric vehicles as set forth in claim 2, further comprising:
determining whether the EHS is in a normal state or an abnormal state when the controller determines that one or more of the predetermined operating conditions of the EHS have been satisfied.

4. The hill start assist control (HAC) method for use in a hybrid electric vehicle as set forth in claim 1, further comprising:
checking one or more release conditions of the EHS to determine whether the EHS has satisfied one or more predetermined release conditions; and
in response to determining that one or more predetermined release conditions of the EHS have been satisfied, turning off an EHS valve of the EHS to release the EHS.

5. The hill start assist control (HAC) method for use in hybrid electric vehicles as set forth in claim 4, wherein when one or more predetermined release conditions of the EHS have not been satisfied, the method further comprises:
comparing and examining an actual torque transmitted to a wheel shaft of the hybrid electric vehicle and a calculated torque calculated based on a slope angle of the slope; and
sending a release signal to the EHS when the actual torque is larger than the calculated torque.

6. A system installed in a hybrid electric vehicle, the system comprising:
an easy hill starter (EHS); and
a controller in communication with the EHS, the controller configured to determine an operational state of the EHS in response to detecting that the hybrid electric vehicle has stopped and is restarting on a slope, and release the operational state of the EHS when it is determined by the controller that the EHS should be operated.

7. The system of claim 6, wherein the controller is further configured to:
check one o more operating conditions of the EHS to determine whether the EHS has satisfied one or more predetermined operating condition; and
check whether the EHS is being operated to apply force to a brake when one or more predetermined operating conditions of the EHS have been satisfied.

8. The system of claim 7, wherein the controller is further configured to:
determine whether the EHS is in a normal state or an abnormal state when the controller determines that one or more of the predetermined operating conditions of the EHS have been satisfied.

9. The system of claim 6, wherein the controller is further configured to:
check one or more release conditions of the EHS to determine whether the EHS has satisfied one or more predetermined release conditions; and
turn off an EHS valve of the EHS to release the EHS in response to a determination that one or more predetermined release conditions of the EHS have been satisfied,

10. The system of claim 6, wherein when one or more predetermined release conditions of the EHS have not been satisfied, the controller is further configured to:
compare and examine an actual torque transmitted to a wheel shaft of the hybrid electric vehicle and a calculated torque calculated based on a slope angle of the slope; and
send a release signal to the EHS when the actual torque is larger than the calculated torque.

11. A computer readable medium containing executable program instructions executed by a controller installed in a hybrid electric vehicle, comprising:
program instructions that determine an operational state of the EHS when the hybrid electric vehicle is stopped and restarted on a slope; and
program instructions that control the operational state of the EHS to release the operational state of the EHS when it is determined by the controller that the EHS should be operated.

12. The computer readable medium of claim 11, further comprising:
program instructions that check one o more operating conditions of the EHS to determine whether the EHS has satisfied one or more predetermined operating condition; and
program instructions that check whether the EHS is being operated to apply force to a brake when one or more predetermined operating conditions of the EHS have been satisfied.

13. The computer readable medium of claim 12, further comprising:
program instructions that determine whether the EHS is in a normal state or an abnormal state when the controller determines that one or more of the predetermined operating conditions of the EHS have been satisfied.

14. The computer readable medium of claim 11, further comprising:
program instructions that check one or more release conditions of the EHS to determine whether the EHS has satisfied one or more predetermined release conditions; and
program instructions that turn off an EHS valve of the EHS to release the EHS in response to a determination that one or more predetermined release conditions of the EHS have been satisfied,

15. The computer readable medium of claim 11, wherein when one or more predetermined release conditions of the EHS have not been satisfied, further comprising:
program instructions that compare and examine an actual torque transmitted to a wheel shaft of the hybrid electric vehicle and a calculated torque calculated based on a slope angle of the slope; and
program instructions that send a release signal to the EHS when the actual torque is larger than the calculated torque.
